(19) United States
(12) Patent Application Publication
(10) Pub. No.: US 2025/0292160 A1
(43) Pub. Date: Sep. 18, 2025

(54) SYSTEM AND METHOD FOR ASSISTING A USER WITH SEAT SELECTION AT AN OUTDOOR VENUE

(71) Applicant: CURTIS BRADLEY, WEST SOMERSET, KY (US)

(72) Inventor: CURTIS BRADLEY, WEST SOMERSET, KY (US)

(21) Appl. No.: 18/603,684

(22) Filed: Mar. 13, 2024

(51) Int. Cl. G06Q 10/02; G06T 11/60

(52) U.S. Cl. CPC G06Q 10/02; G06T 11/60

(57) ABSTRACT

A system and method for assisting a user with seat selection at an outdoor venue is provided. The system and method help users to determine whether a particular seat at an outdoor venue will be in the sun or shade during the event before they purchase a ticket. Through a user device such as a mobile phone or PC, a user selects a seat and can determine whether that seat will be in the sun or shade during the event. This is accomplished by using data regarding the position of the sun relative to the seat and considers structural features of the venue that may block the sun from shining on the seat given the position of the sun in the sky at that particular moment.

### BACKGROUND OF THE INVENTION

### Field of the Invention

This disclosure relates generally to systems and methods for providing information to a user about the quality of a seat at an event, and more particularly to a system and method that provides information to a user about whether a particular seat is in the sun or shade at a particular time during the event.

### Description of the Related Art

Although personal sales used to be the norm for ticketing, that is no longer the case. A large portion of eventgoers now purchase tickets through ticketing websites. A difficulty with these purchases is the limitation on a user's ability to determine and select the quality and location of individual seats. Some conventional ticketing websites provide seating charts, but conventional seating charts still fail to provide important information that may be relevant to decision-making.

People want to know as much information as possible about a seat in a venue before they purchase a ticket for that seat. People often complain when they pay a significant amount of money for a ticket and then they have a bad experience because their view of the main viewing area (e.g., a field in the case of a baseball or football or a stage at a musical or theatrical performance) is poor or does not meet expectations. One such area of concern involves whether the seat is in the sun or shade during the event. On extremely hot days, a person may wish to avoid the sun beating down on him/her and it would be preferably to have a seat that is shaded from the sun. Conversely, on a cold or milder day, an event goer may wish to have a seat that is in the sun rather than the shade, thus providing additional the additional warmth and comfort of the direct sunshine.

Accordingly, there is a need for a system and method for assisting a user in selecting a seat at an outdoor venue that allows the user to determine whether a particular seat will be in the sun or shade during the event to maximize the comfort of the event goer during the event.

### SUMMARY OF THE INVENTION

It is therefore an object of the present invention to provide a system and method that allows an eventgoer to quickly and easily determine whether a particular seat at a venue is in the sun or in the shade during a particular event. The present invention meets these objects by providing a system and method for assisting a user with seat selection at an outdoor venue.

According to one presently preferred embodiment of the invention, there is provided a system comprising a memory configured to store data relative to a venue, including structural features of the venue and location data regarding a plurality of seats in the venue; and one or more processors in communication with the memory. The processors are configured to receive from a user device a seat selection from the plurality of seats; receive data regarding a position of the sun relative to the seat selection and the structural features of the venue; perform solar location to determine the position of the sun relative to the seat selection and the structural features of the venue during a time frame associated with an event at the venue; determine, based on the position of the sun, position of the seat selection, and position of structural features of the venue, whether the seat selection is in the sun or in the shade during the time frame associated with the event at the venue; and present the determination of whether the seat selection is in the sun or shade to the user device.

The one or more processors are configured to display on the user device views of a viewing area of the venue from a perspective of the seat selection. The one or more processors may be further configured to visually project a shadow onto the display of the viewing area based on the determination of the position of the sun. The shadow may be dynamically displayed onto the display of the viewing area during the entire time frame associated with the event.

According to a further embodiment of the invention, there is provided a method for assisting a user in selecting a seat at a venue. A seat selection from a plurality of seats in a venue is received from a user device. Next, data is received regarding a position of the sun relative to the seat selection and structural features of the venue. Solar location is then performed to determine the position of the sun relative to the seat selection and the structural features of the venue during a time frame associated with an event at the venue. Next, based on the position of the sun, position of the seat selection, and position of structural features of the venue, it is determined whether the seat selection is in the sun or in the shade during the time frame associated with the event at the venue. Lastly, a determination of whether the seat selection is in the sun or shade is presented to the user device.

The method may further comprise displaying on the user device views of a viewing area of the venue from a perspective of the seat selection. The presenting may further comprise projecting a shadow onto the display of the viewing area based on the determination of the position of the sun. Further, the presenting may comprise dynamically displaying the shadow onto the display of the viewing area during the entire time frame associated with the event.

A further embodiment of the invention is a non-transitory machine-readable medium having stored thereon machine-readable instructions executable to cause a machine to perform operations. The operations performed by the non-transitory machine-readable medium comprise: receiving from a user device a seat selection from a plurality of seats in a venue; receiving data regarding a position of the sun relative to the seat selection and structural features of the venue; performing solar location to determine the position of the sun relative to the seat selection and the structural features of the venue during a time frame associated with an event at the venue; determining, based on the position of the sun, position of the seat selection, and position of structural features of the venue, whether the seat selection is in the sun or in the shade during the time frame associated with the event at the venue; and presenting the determination of whether the seat selection is in the sun or shade to the user device.

The operations may further comprise displaying on the user device views of a viewing area of the venue from a perspective of the seat selection. The operations may also comprise projecting a shadow onto the display of the viewing area based on the determination of the position of the sun. The operations may further comprise dynamically displaying the shadow onto the display of the viewing area during the entire time frame associated with the event.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a is a block diagram of a prior art networked system suitable for implementing the methods described herein according to a presently preferred embodiment of the invention;

FIG. 2 is a block diagram of a prior art computer system suitable for implementing one or more components in FIG. 1 according to one presently preferred embodiment of the invention; and

FIG. 3 is a flowchart showing a method for assisting a user with selection of a seat at an outdoor venue according to a presently preferred embodiment of the invention.

### DETAILED DESCRIPTION OF THE INVENTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

The present invention involves systems and methods for providing a user with more information about a particular seat at a venue. In particular, the systems and methods of the present invention help users understand and predict whether a particular seat at an outdoor venue will be in the sun or shade during the event in question before they purchase a ticket.

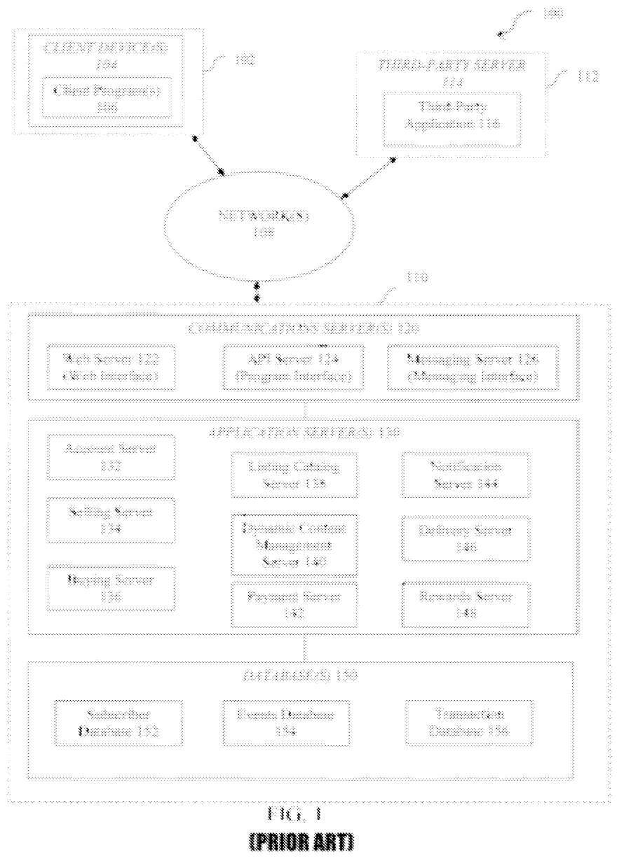

As shown in FIG. 1, an exemplary embodiment of a computing system adapted for implementing one or more processes involving assisting a user at an event is illustrated in block diagram format. As shown, computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a user 102 that may comprise or employ one or more user devices 104, such as a mobile computing device, a wearable computing device such as a smart watch or smart goggles, a PC, and/or any other computing device having computing and/or communications capabilities in accordance with the described embodiments. User devices 104 generally may provide one or more user programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VOIP, video messaging), contacts application, calendar application, electronic document application, database application, media application (e.g., music, video, television), location-based services (LBS) application (e.g., GPS, mapping, directions, point-of-interest, locator), and so forth. One or more of user programs 106 may display various graphical user interfaces (GUIs) to present information to and/or receive information from one or more of user devices 104.

As shown, user 102 can be communicatively coupled via one or more networks 108 to a network-based system 110 managed by an online service provider. Network-based system 110 may be structured, arranged, and/or configured to allow user 102 to establish one or more communication sessions with network-based system 110 using various computing devices 104 and/or user programs 106. Accordingly, a communication session between user 102 and network-based system 110 may involve the unidirectional and/or bidirectional exchange of information and may occur over one or more types of networks 108 depending on the mode of communication. While the embodiment of FIG. 1 illustrates a computing system 100 deployed in a user-server operating environment, it is to be understood that other suitable operating environments and/or architectures may be used in accordance with the described embodiments.

Data and/or voice communications between user 102 and the network-based system 110 may be sent and received over one or more networks 108 such as the Internet, a WAN, a WWAN, a WLAN, a mobile telephone network, a landline telephone network, a VoIP network, as well as other suitable networks. For example, user 102 may communicate with network-based system 110 over the Internet or other suitable WAN by sending and or receiving information via interaction with a web site, e-mail, IM session, and/or video messaging session. Any of a wide variety of suitable communication types between user 102 and system 110 can take place, as will be readily appreciated.

In various embodiments, computing system 100 can include, among other elements, a third party 112, which may comprise or employ a third-party server 114 hosting a third-party application 116. In various implementations, third-party server 114 and/or third-party application 116 may host a web site associated with or employed by a third party 112. For example, third-party server 114 and/or third-party application 116 may enable network-based system 110 to provide user 102 with additional services and/or information, such as additional ticket inventory. In some embodiments, one or more of user programs 106 may be used to access network-based system 110 via third party 112. For example, user 102 may use a web user to access and/or receive content from network-based system 110 after initially communicating with a web site of third-party 112.

Network-based system 110 may comprise one or more communication servers 120 to provide suitable interfaces that enable communication using various modes of communication and/or via one or more networks 108. Communication servers 120 can include a web server 122, an API server 124, and/or a messaging server 126 to provide interfaces to one or more application servers 130. Application servers 130 of network-based system 110 may be structured, arranged, and/or configured to provide various online marketplace and/or ticket fulfillment services to users that access network-based system 110. In various embodiments, user 102 may communicate with application servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of user devices 104 and/or user programs 106 and may interoperate with each other in some implementations.

Web server 122 may be arranged to communicate with web users and/or applications such as a web browser, web browser toolbar, desktop widget, mobile widget, web-based application, web-based interpreter, virtual machine, and so forth. API server 124 may be arranged to communicate with various user programs 106 and/or a third-party application 116 comprising an implementation of API for network-based system 110. Messaging server 126 may be arranged to communicate with various messaging users and/or applications such as e-mail, IM, SMS, MMS, telephone, VOIP, video messaging, and so forth, and messaging server 126 may provide a messaging interface to enable access by user 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, dynamic content management services, delivery services, payment services, and notification services. Application servers 130 may include an account server 132, a buying server 134, a selling server 136, a listing catalog server 138, a dynamic content management server 140, a payment server 142, a notification server 144, and/or a delivery server 146 structured and arranged to provide such online marketplace and ticket fulfillment services. Application servers 130 are adapted to receive a user's seat selection, retrieve pictures, display views from a selected seat, and display information regarding the location of the sun relative to the selected seat. This enables the user to determine whether the selected seat will be in the sun or shade during a specific event at a certain time at the venue.

Application servers 130 may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

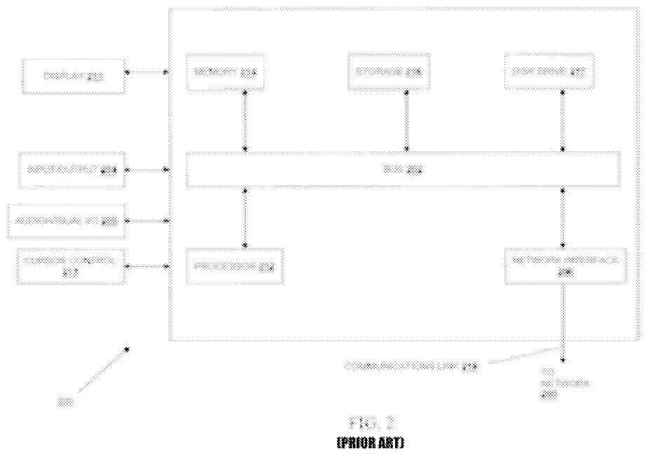

Continuing with FIG. 2, an exemplary computer system 200 suitable for implementing one or more devices of the computing system in FIG. 1 is depicted in block diagram format. In various implementations, a device that includes computer system 200 may comprise a personal computing device (e.g., a smartphone, a computing tablet, a personal computer, laptop, PDA, Bluetooth device, key FOB, badge, etc.) that is capable of communicating with a network. The service provider may utilize a network computing device (e.g., a network server) capable of communicating with the network. It should be appreciated that each of the devices utilized by users and service providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, or a payment provider server via a network. In one embodiment, the transmission is wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

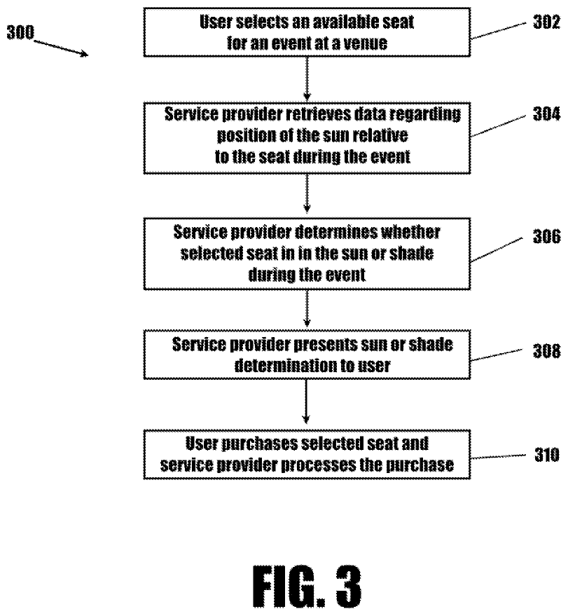

Referring now to FIG. 3, a flowchart of a method 300 for improving seat selection at a venue is illustrated according to an embodiment of the present disclosure. It should be appreciated that the method illustrated in the embodiment of FIG. 3 may be implemented by the systems illustrated in FIG. 1 and/or FIG. 2 according to one or more embodiments.

In various embodiments, the user 102 registers with a service provider, which runs a mobile application. Registration may include signing up for the service and agreeing to any terms required by the service provider, such as through a user device. In one embodiment, the user device is a mobile computing device, such as a smart phone, a PC, or a computing tablet. In other embodiments, registration may be done completely through the user device, partially through the user device, or without using the user device, such as through a phone call or in-person visit to a representative of the service provider.

The user may be requested to provider specific information for registration, such as, but not limited to, a name, address, phone number, email address, picture, a user name for the account, and a password or PIN for the account. The type of information may depend on whether the user already has an account with the service provider. Requested information may be entered through the user device or other means, including voice or manual key entry. Once all the requested information is received and confirmed, the service provider may create an account for the user.

The method 300 begins at step 302, where the user 102 selects an available seat for an event at a venue. For example, the user 102 may go to a ticketing website, select an event, and consider a seating chart that displays seats available for purchase at the event.

In various embodiments, the seating chart is interactive, and the system 110 enables the user 102 to select seats through a website. The system 110 may perform one or more of the following functions: present information about a plurality of upcoming performances; enable selection of at least one performance for possible attendance; search for available seats across one or more performances; provide a seating chart of a selected performance with seating information including current availability; enable selection of one or more seats from the seating chart; save (i.e., hold) the selected seat(s) for possible future purchase; remove the saved seat(s) from the inventory of currently available seating to prevent another person from purchasing same; enable purchase of the selected seats; transmit electronic communications to customers regarding seat selections or purchases; and provide the purchaser with the option of receiving electronic ticketing.

The seating chart rendering can be approximate, in that it need not be photo-realistic, but it may be designed to represent the actual venue. It can depict seat locations and physical structures, such as walls, floors, stage, or obstructions.

In some embodiments, system 110 may enable user 102 to bookmark one or more seats, performances, events, or venues. The bookmarks can then be associated with the user 102 within a user profile. At a later time, the user 102 may use the bookmark to link to the seats, performances, events, or venues that were marked. The user 102 may thus use the bookmark to check the availability of seats previously marked and, if desired, to purchase the seats if they are available.

For each event, events database 154 may maintain data indicating the status of some or all seats for each performance. The database 154 may store information about which seats are available for sale, which seats are on hold, and which seats are bookmarked for updates. The identification of a seat for a particular event may vary based on the event or the venue in which it is held. For example, if an event is general admission only, then the seat availability data may be implemented to keep track of the number of available seats, or the general sections of the seats, instead of identifying the specific location of each available seat. In contrast, if an event requires specific, reserved seats, then database 154 may track the status of each individual seat in the venue.

At step 304, the system 110 retrieves data regarding the position of the sun relative to the earth. More particularly, the system 110 retrieves data regarding the position of the sun relative to the selected seat at the venue on the date(s) and at the time(s) associated with the selected event. The data regarding the position of the sun can be obtained from a third party site, or, alternatively, it could be stored in one of the databases 150, for example the event database 154. The system 110 preferably retrieves data regarding the position of the sun during the entire duration of the event. For example, if an event begins at 2:00 pm and ends at 4:00 pm, the system 110 will retrieve data regarding the sun's position and movement during that time period.

At step 306, the system 110 performs a solar location function and makes a determination as to whether the selected seat is in the sun or shade during the event. This is accomplished by first taking into account the location of the selected seat relative to the sun at all times during the event. The system 110 then takes into account any objects that may be positioned between the sun and the selected seat during the event which may cast a shadow on the selected seat. Such objects may include but are not limited to structural features of the venue such as roofs, overhangs, scoreboards, lights, skybox suites, railings, and the like. If one of those structural features is located between the sun and the selected seat at a particular time during the event, the system calculates the shadow that the feature would cast over the seat. As the sun moves across the sky, the system tracks the movement of that shadow relative to the selected seat as well.

At step 308, the system 110 provides feedback information to the user indicating whether the seat is in the sun or shade during the event. The feedback information can be in the form of a specific message indicating the times during which the selected seat is in the sun or in the shade. Alternatively, the feedback can consist of picture data depicting the selected seat, it's view of the field, and an overlay of any shadows cast over the selected seat and the surrounding area.

At step 310, the user 102 decides to purchase the ticket for the selected seat, and the purchase is processed. Alternatively, the user 102 may choose to search for another available seat if he or she decides that fact that the seat will be in the sun or shade will negatively affect his or her enjoyment of the event or performance.

### Example

John wants to purchase a ticket to see the St. Louis Cardinals vs. the Chicago Cubs at Busch Stadium on July 4^{th}. The first pitch is scheduled to be thrown out at 2:15 pm and the game is expected to last for two hours and thirty-eight minutes. The forecasted temperature at gametime is 101 degrees Fahrenheit. In order to avoid the direct rays of the sun, John would clearly prefer to have a seat in the shade for this game.

John uses his ticket application (“app”) to buy tickets to the game. John sees pictures that show views of the field from each of the available seats. Thinking that it is an afternoon game and the seats on the west side of the stadium might be in the shade, John selects an available seat in Section 156 along the third base line. It turns out the seat John selected would be in the sun for the first 56 minutes of the game and in the shade for the remainder of the game.

Given this information, John then selects a seat two sections over in Section 158. According to the calculations made by the app, this seat will be in the shade for the duration of the game. John now has a better game experience because he was able to understand exactly how the position of the sun relative to the selected seat and the features of the stadium would affect his experience. He knew that given the forecasted heat for the day in question, a seat in the shade would be much more comfortable. Thanks to the app, John was able to determine that his selected seat would in fact be in the shade for the entire game before he purchased the ticket.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

1. A system, comprising:
a venue database configured to store data relative to a selected venue, including location information of permanent, fixed structural features of the selected venue and seat location data regarding a plurality of seats in the venue;
an environmental database that includes data regarding the position of the sun relative to the earth during a selected time frame;
and
a processor in communication with the venue database and the environmental database, the processor being capable to execute computer-readable instructions that, when executed by the processor, cause the processor to:
receive as a user selection from a user device a seat selection from the plurality of seats at a date and time frame for a selected event;
access the venue database and retrieve data regarding the selected venue including a coordinate location of the seat selection and location information of permanent, fixed structural features of the selected venue;
access the environmental database and retrieve data regarding the position of the sun relative to the earth during the time frame for the selected event;
determine, by a processor, based on the coordinate location of the seat selection, the location information of the permanent, fixed structural features of the venue and the location of the sun relative to the earth during the time frame for the selected event, whether the seat selected by the user selection is in the sun or in the shade; and
present, via a user interface on an electronic display of the user device the determination of whether the seat selection is in the sun or shade.

2. The system of claim 1, wherein the one or more processors are further configured to display on the user device views of a viewing area of the venue from a perspective of the seat selection.

3. The system of claim 2, wherein the one or more processors are further configured to visually project a shadow onto the display of the viewing area based on the determination of the position of the sun.

4. The system of claim 3, wherein the one or more processors are further configured to dynamically display the shadow onto the display of the viewing area during the entire time frame associated with the event.

5. A method for assisting a user in determining whether a selected seat at a selected venue during a selected event at a selected time frame is located in the sun or in the shade, the method comprising:
receiving, via a user device, a seat selection from a plurality of seats in the selected venue at the selected event, at the selected time frame;
accessing a venue database that includes data regarding the selected venue including a coordinate location of the seat selection and location information of permanent, fixed structural features of the selected venue;
accessing an environmental database that includes data regarding the position of the sun relative to the earth during the selected time frame;
determining, by a processor, based on the coordinate location of the seat selection, the location information of the permanent, fixed structural features of the venue and the location of the sun relative to the earth during the selected time frame, whether the seat selection is in the sun or in the shade; and
automatically presenting, via a user interface on an electronic display of the user device the determination of whether the seat selection is in the sun or shade.

6. The method of claim 5, wherein the presenting comprises displaying on the user device views of a viewing area of the venue from a perspective of the seat selection.

7. The method of claim 6, wherein the presenting further comprises projecting a shadow onto the display of the viewing area based on the determination of the position of the sun.

8. The method of claim 7, wherein the presenting further comprises dynamically displaying the shadow onto the display of the viewing area during the entire time frame associated with the event.

9. A non-transitory machine-readable medium having stored thereon machine-readable instructions executable to cause a machine to perform operations comprising:
receiving, as a user selection from a user device, a seat selection from a plurality of seats in a venue at a date and a selected time frame for a selected event;
accessing a venue database that includes data regarding the selected venue including a coordinate location of the seat selection and location information of permanent, fixed structural features of the selected venue;
accessing an environmental database that includes data regarding the position of the sun relative to the earth during the selected time frame;
determining, by a processor, based on the coordinate location of the seat selection, the location information of the permanent, fixed structural features of the venue and the location of the sun relative to the earth during the selected time frame, whether the selected seat is in the sun or in the shade during the selected time frame; and
automatically presenting, via a user interface on an electronic display of the user device the determination of whether the seat selection is in the sun or shade.

10. The non-transitory machine-readable medium of claim 9, the operations further comprising displaying on the user device views of a viewing area of the venue from a perspective of the seat selection.

11. The non-transitory machine-readable medium of claim 10, the operations further comprising projecting a shadow onto the display of the viewing area based on the determination of the position of the sun.

12. The non-transitory machine-readable medium of claim 11, the operations further comprising dynamically displaying the shadow onto the display of the viewing area during the entire time frame associated with the event.
